(19) United States
(12) Patent Application Publication
(10) Pub. No.: US 2004/0122772 A1
(43) Pub. Date: Jun. 24, 2004

(54) Method, system and program product for protecting privacy

(75) Inventor: Andrew L. Schirmer, Andover, MA (US)

Correspondence Address: IBM Corporation, N50/040-4, 1701 North Street, Endicott, NY, 13760, US

(73) Assignee: International Business Machines Corporation, Armonk, NY

(21) Appl. No.: 10/323,279

(22) Filed: Dec. 18, 2002

(51) Int. Cl. G06F 17/60

(52) U.S. Cl. 705/50

(57) ABSTRACT

Under the present invention, a data item is obtained from a private data source. Upon reception, a relationship of the data item to an entity is identified. Then, approval to publish the data item is obtained from a data item approver. Once the data item has been approved for publication, approval to publish the relationship is obtained from a relationship approver. Once approval is obtained from both the data item approver and the relationship approver, the data item and the relationship will be published.

### BACKGROUND OF THE INVENTION

1. Field of the Invention

In general, the present invention relates to a method, system and program product for protecting privacy. Specifically, the present invention provides a double-blind process for protecting privacy of a data item and a relationship of the data item to an entity.

2. Background Art

As the use of computer technology becomes more pervasive, the need to distinguish between public data and private data becomes increasingly important. Specifically, some data items residing on a system may be fit for publication, while other data items might need to be kept private. Currently, there exist systems that extract data from public and/or private data sources with the intent of making the data public. Some systems take the additional step of publishing relationships between entities (individuals, groups of individuals, etc.) and the data. For example, a data item might include a set of telephone numbers. These telephone numbers could relate to people who work in a particular department of a business. Extracting and publishing data from public sources generally avoids privacy concerns since publication only reveals that which has been previously published.

However, many entities store useful data on private systems. For example, issues important to a business could be contained in electronic mail messages stored on the business' electronic mail server. On many occasions, the data is communicated in electronic mail messages is not private per se, but the relationship of the data to certain people is. Since data sources such as electronic mail servers are not considered to be public, privacy controls are required before publication of either the data or the relationships.

In view of the foregoing, there exists a need for a method, system and program product for protecting privacy. Specifically, a need exists for a way to protect privacy of a data item as well as any relationship of the data item to an entity. A further need exists for approval to publish the data item as well the relationship to be obtained before either one is published.

### SUMMARY OF THE INVENTION

In general, the present invention provides a method, system and program product for protecting privacy. Specifically, the present invention provides a double-blind process for approving publication of a data item and a corresponding relationship of the data item to an entity (e.g., individual, group of individuals, etc.). Under the present invention, a data item is obtained from a private data source. Once received, any relationship of the data item to an entity is identified. Once the relationship is identified, approval to publish the data item will be determined by a data item approver. If such publication is approved, approval to publish the relationship is determined by a relationship approver. If both the data item approver and the relationship approver give their approvals, the data item and the relationship will be published.

According to a first aspect of the present invention, a method for protecting privacy is provided. The method comprises: (1) obtaining a data item from a private source; (2) identifying a relationship of the data item to an entity; (3) obtaining approval to publish the data item from a data item approver; (4) obtaining approval to publish the relationship from a relationship approver; and (5) publishing the data item and the relationship if approval is received from both the data item approver and the relationship approver.

According to a second aspect of the present invention, a system for protecting privacy is provided. The system comprises: (1) a data item system for obtaining a data item from a private source; (2) a relationship system for identifying a relationship of the data item to an entity; (3) a data approval system for approving publication of the data item; (4) a relationship approval system for approving publication of the relationship; and (5) a publication system for publishing the data item and the relationship, wherein the data item and the relationship are published only if approval to publish both the data item and the relationship is obtained.

According to a third aspect of the present invention, a program product stored on a recordable medium for protecting privacy is provided. When executed, the program product comprises: (1) program code for obtaining a data item from a private source; (2) program code for identifying a relationship of the data item to an entity; (3) program code for approving publication of the data item; (4) program code for approving publication of the relationship; and (5) program code for publishing the data item and the relationship, wherein the data item and the relationship are published only if approval to publish both the data item and the relationship is obtained.

Therefore, the present invention provides a method, system and program product for protecting privacy.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a method flow diagram according to the present invention.

FIG. 2 depicts computer system having a privacy system for carrying out the method of FIG. 1.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method, system and program product for protecting privacy. Specifically, the present invention provides a double-blind process for approving publication of a data item and a corresponding relationship of the data item to an entity (e.g., individual, group of individuals, etc.). Under the present invention, a data item is obtained from a private data source. Once received, any relationship of the data item to an entity is identified. Once the relationship is identified, approval to publish the data item will be determined by a data item approver. If such publication is approved, approval to publish the relationship is determined by a relationship approver. If both the data item approver and the relationship approver give their approvals, the data item and the relationship will be published.

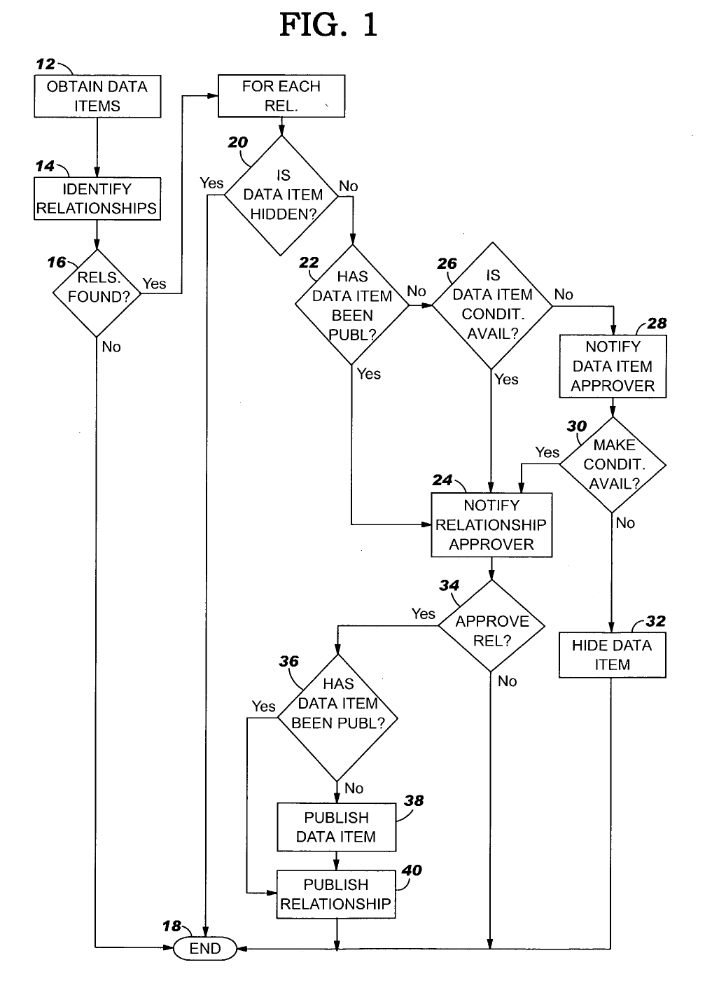

Referring now to FIG. 1, method flow diagram of the process of the present invention is shown. The flow diagram is intended to represent the privacy control of the present invention when publishing a data item and any relationships thereof to an entity. As depicted, first step 12 is to extract/obtain data items from a private data source. As indicated above, a data item could be fit for publication although it is stored on a private data source. For example, a company's electronic mail server could contain a data item (i.e., within electronic mail messages) that is not private and would be beneficial if published. The present invention provides the possibility to take advantage of such a data item by obtaining it from the private source. Under the present invention, the private source can be any system that contains data and that is not generally available to the public. Examples include, among other things, a storage system (e.g., a database), a server, etc.

Once the data item has been obtained, any relationship(s) between the data item and an entity will be identified in step 14. In one embodiment, a relationship is identified by analyzing meta data pertaining to the data item. For example, if the data item is a word processing document attached to an electronic mail message, the sender of the message could be presumed to be the author of the document. Thus, one possible relationship is “Joe Smith is the author of document A.” Alternatively, a relationship could be identified by parsing/analyzing the data item itself. For example, document “A” could be parsed for keywords or the like that would reveal the author's identify (e.g., “authored by”). In another embodiment, the relationship(s) could be provided by an outside relationship source (e.g., a storage system, a server, an administrator, “smart” system, etc.). If the relationship source is a storage device, it could include a table that associates the data items in the private data source with particular entities.

In step 16, it will be determined whether any relationships of the data item to an entity were successfully identified. If not, the process will terminate in step 18. If, however, one or more relationships were identified, it will then be determined (for each identified relationship) whether the data item and corresponding relationship can be published. To this extent, it can be determined whether the data item was “hidden” (i.e., previously determined to be private) in step 20. If it was hidden, the process will terminate in step 18. If, however, the data item was not “hidden,” it will be determined whether the data item has already been published in step 22. If so, there is no need to obtain approval to publish the data item. In this case, a relationship approver will be notified in step 24 to determine whether publication of the relationship should be approved. If, however, the data item has not been published, it will be determined whether the data item is “conditionally available” in step 26. “Conditional availability” means that the data item was approved for publication pending approval of a relationship, but it has not actually been published yet. If the data item is “conditionally available,” the relationship approver will be notified in step 24 to determine whether publication of the relationship should be approved. In the event that the data item is not “conditionally available,” a data item approver will be notified in step 28. In step 30, the data item approver will decide whether to approve of publication of the data item (i.e., make the data item “conditionally available”), or to disapprove of publication of the data item. In determining whether to approve or disapprove of publication of the data item, the data item approver could use any criteria, rules and/or policies such as whether the information is valuable and/or secret, whether the information is accurate, etc. To this extent, the data item approver can be an individual, group of individuals, “expert” system, etc. that can apply criteria, rules and/or policies to determine whether to approve of the publication of the data item.

In any event, if the data item approver disapproves of the publication of the data item, the data item will be “hidden” in step 32 and the process will terminate in step 18. If, however, publication of the data item is approved, the relationship approver will be notified to determine whether publication of the relationship should be approved in step 24. Once notified in step 24, the relationship approver will determine whether publication of the relationship is approved in step 34. Similar to the data item approver, the relationship approver could be an individual, group of individuals, “expert” system, etc. that uses any criteria, rules and/or policies in approving or disapproving of publication of the relationship. For example, the relationship approver could examine whether the purported relationship is correct, whether the relationship is confidential, etc. If the relationship approver disapproves of the publication for any reason, the process will terminate in step 18, or until an acceptable relationship is identified. If, however, the relationship approver approves the publication of the relationship, it will be determined whether the data item has been published already in step 36. If not, the data item will be published in step 38, which will be followed by publication of the relationship in step 40 and termination of the process in step 18. If, however, the data item has already been published, the relationship will be published in step 40, and the process will then terminate in step 18.

In a typical embodiment, all information about the relationship and the relationship approver remains hidden from the data item approver (and vice versa), at least until both the data item and the relationship are approved for publication. This helps maintain system integrity by reducing conflicts between the data item approver and the relationship approver. As can be seen from the above description, the present invention provides a more private process for publishing a data item as well its relationship to an entity. Specifically, under the present invention, before either the data item or the relationship can be published, approval for publication of both must be received (e.g., from the data item approver and the relationship approver).

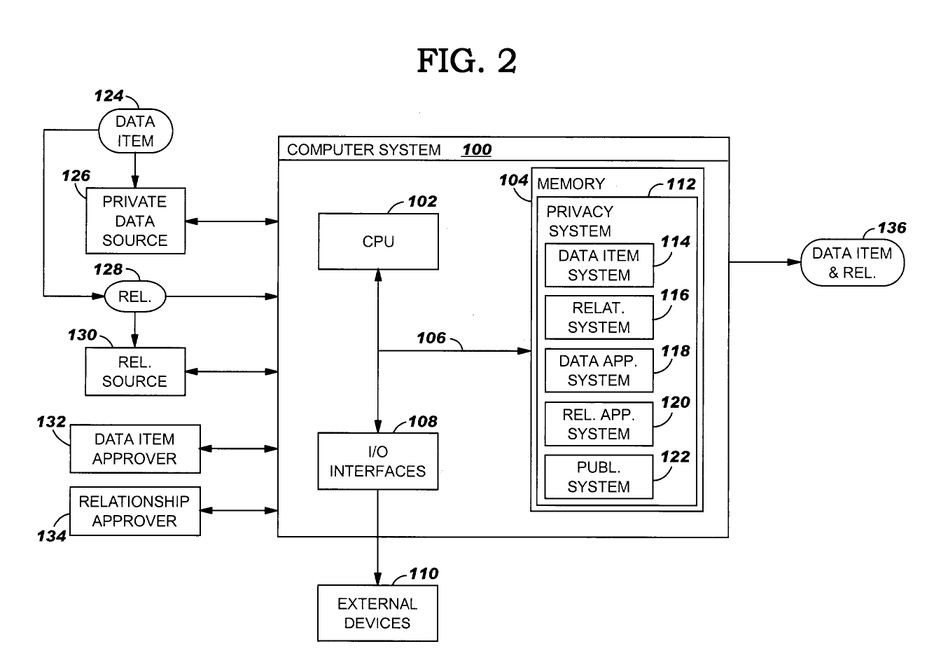

Referring now to FIG. 2, computer system 100 having privacy system 112 for carrying out the functions described above is depicted. As shown, computer system 100 generally comprises central processing unit (CPU) 102, memory 104, bus 106 input/output (I/O) interfaces 108 and external devices/resources 110. CPU 102 may comprise a single processing unit, or be distributed across one or more processing units in one or more locations, e.g., on a client and server. Memory 104 may comprise any known type of data storage and/or transmission media, including magnetic media, optical media, random access memory (RAM), read-only memory (ROM), a data cache, a data object, etc. Moreover, similar to CPU 102, memory 104 may reside at a single physical location, comprising one or more types of data storage, or be distributed across a plurality of physical systems in various forms.

I/O interfaces 108 may comprise any system for exchanging information to/from an external source. External devices/resources 110 may comprise any known type of external device, including speakers, a CRT, LED screen, hand-held device, keyboard, mouse, voice recognition system, speech output system, printer, monitor, facsimile, pager, etc. Bus 106 provides a communication link between each of the components in computer system 100 and likewise may comprise any known type of transmission link, including electrical, optical, wireless, etc. In addition, although not shown, additional components, such as cache memory, communication systems, system software, etc., may be incorporated into computer system 100.

It should be understood that communication with computer system 100 can occur via a direct hardwired connection (e.g., serial port), or via an addressable connection in a client-server (or server-server) environment which may utilize any combination of wireline and/or wireless transmission methods. In the case of the latter, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Stored in memory 104 of computer system 100 is privacy system 112. Privacy system 112 helps carry out the functions described above in conjunction with FIG. 1 and generally includes data item system 114, relationship system 116, data approval system 118, relationship approval system 120 and publication system 122. Under the present invention, when publication of data item 124 and relationship(s) 128 thereof to an entity is desired, data item system 114 will first obtain/extract the data item from private data source 126. Once obtained, relationship system 116 will identify relationship(s) 128 of data item 124 to an entity. As indicated above, relationship(s) 128 could be identified in any manner now known or later developed. For example, relationship system 116 could identify relationship(s) 128 by analysis (e.g., by analyzing meta data relating to data item 114, by parsing data item 128, etc.). In another embodiment, relationship(s) 128 is provided by relationship source 130, which could be any storage system, server, administrator, “expert” system, etc. that contains or has knowledge of relationship(s) 128. In this case, relationship source 130 could be queried by relationship system 116 to identify relationship(s) 128.

In the event that private data source 126 and/or relationship source 130 comprise storage systems, one or more databases could be provided. Moreover, private data source 126 and/or relationship source 130 and may include one or more devices, such as a magnetic disk drive or an optical disk drive. In another embodiment, private data source 126 and relationship source 130 include data distributed across, for example, a local area network (LAN), wide area network (WAN) or a storage area network (SAN) (not shown).

In any event, when relationship(s) 128 is identified, data approval system 118 will coordinate the approval of data item 124 for publication. As shown in method flow diagram 10 of FIG. 1, data approval system will first determine whether the data item has been previously published or made conditionally available. In either case, data item system 114 will forego receiving approval from data item approver 132, and relationship approval system 116 will seek approval to publish relationship(s) 128 from relationship approver 134. If, however, data item 124 was neither published nor made “conditionally available,” data item approver 132 will be contacted by data item approval system 118 to determine whether data item 124 should be approved for publication. If approved, such approval will then be received by data item approval system 118, which will characterize data item 124 as “conditionally available.” As indicated above, data item approver 132 could be an individual, group of individuals, “expert” system, etc. that uses criteria, rules and/or policies in determining whether to approve of publication of data item 124. To this extent, data item approver 132 could be program code that is internal to data approval system 118, instead of an outside system as shown. As such, data item approver 132 is shown as an external system for illustrative purposes only.

In any event, once data item 124 is approved by data item approver 132, relationship approval system 120 will seek approval to publish relationship(s) 128 from relationship approver 134. Similar to data item approver 132, relationship approver 134 can be an individual, group of individuals, “expert” system that uses criteria, rules and/or policies for determining whether publication of the relationship should be approved. Moreover, although not shown as such, relationship approver 134 could be internal to privacy system 112 (e.g., part of relationship approval system 120). Once both data item approver 132 and relationship approver 134 have given their approvals, publication system 122 will publish data item 124 and relationship 136.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the systems within privacy system 112 can be combined into fewer systems, or further split into additional systems.

What is claimed:

1. A method for protecting privacy, comprising:
obtaining a data item from a private source;
identifying a relationship of the data item to an entity;
obtaining approval to publish the data item from a data item approver;
obtaining approval to publish the relationship from a relationship approver; and
publishing the data item and the relationship if approval is received from both the data item approver and the relationship approver.

2. The method of claim 1, wherein the entity is selected from the group consisting of an individual and a group of individuals.

3. The method of claim 1, wherein neither the data item nor the relationship are published if either the approval from the data item approver or the approval from the relationship approver are not received.

4. The method of claim 1, wherein approval from the data item approver is not necessary if the data item has been previously published.

5. The method of claim 1, wherein approval from the data item approver is not necessary if approval to publish the data item was previously received.

6. The method of claim 1, further comprising requesting the approval to publish the data item from the data item approver, after the identifying step.

7. The method of claim 1, further comprising requesting approval to publish the relationship from the relationship approver, after receiving the approval from the data item approver.

8. A system for protecting privacy, comprising:
a data item system for obtaining a data item from a private source;
a relationship system for identifying a relationship of the data item to an entity;
a data approval system for approving publication of the data item;
a relationship approval system for approving publication of the relationship; and
a publication system for publishing the data item and the relationship, wherein the data item and the relationship are published only if approval to publish both the data item and the relationship is obtained.

9. The system of claim 8, wherein the entity is selected from the group consisting of an individual and a group of individuals.

10. The system of claim 8, wherein neither the data item nor the relationship are published by the publication system if approval to publish either the data item or the relationship is not received.

11. The system of claim 8, wherein approval to publish to data item is not necessary if the data item has been previously published.

12. The system of claim 8, wherein approval to publish the data item is not necessary if approval to publish the data item was previously received.

13. The system of claim 8, wherein approval to publish the data item is obtained from a data item approver.

14. The system of claim 8, wherein approval to publish the relationship is obtained from a relationship approver.

15. A program product stored on a recordable medium for protecting privacy, which when executed, comprises:
program code for obtaining a data item from a private source;
program code for identifying a relationship of the data item to an entity;
program code for approving publication of the data item;
program code for approving publication of the relationship; and
program code for publishing the data item and the relationship, wherein the data item and the relationship are published only if approval to publish both the data item and the relationship is obtained.

16. The program product of claim 15, wherein the entity is selected from the group consisting of an individual and a group of individuals.

17. The program product of claim 15, wherein neither the data item nor the relationship are published if approval to publish either the data item or the relationship is not obtained.

18. The program product of claim 15, wherein approval to publish the data item is not necessary if the data item has been previously published.

19. The program product of claim 15, wherein approval to publish the data item is not necessary if approval to publish the data item was previously received.

20. The program product of claim 15, wherein approval to publish the data item is obtained from a data item approver.

21. The program product of claim 15, wherein approval to publish the relationship is obtained from a relationship approver.
